(19) United States
(12) Patent Application Publication
(10) Pub. No.: US 2013/0119758 A1
(43) Pub. Date: May 16, 2013

(54) MOUNT STRUCTURE TO MOUNT POWER CONTROLLER ON VEHICLE BODY

(71) Applicant: HONDA MOTOR CO., LTD., Tokyo (JP)

(72) Inventors: Hiroyuki TAKAMATSU, Wako (JP); Ryoji TOMOKAGE, Wako (JP); Ryuta WAKABAYASHI, Wako (JP)

(73) Assignee: HONDA MOTOR CO., LTD., Tokyo (JP)

(21) Appl. No.: 13/656,740

(22) Filed: Oct. 22, 2012

(30) Foreign Application Priority Data
Nov. 14, 2011 (JP) 2011-248159

(51) Int. Cl. H02G 3/16

(52) U.S. Cl. 307/9.1; 174/59

(57) ABSTRACT

A mount structure to mount a power controller on a vehicle body includes a power supply line and a unit support frame. The power supply line includes a wiring connecting portion to be connected to the power controller, and an outer wiring portion extending from the wiring connecting portion along an end face of the power controller. The end face is provided to face in a widthwise direction of the vehicle body. The unit support frame is to support the power controller and includes a widthwise outer frame extending along the end face of the power controller. The widthwise outer frame is disposed outward of the outer wiring portion in the widthwise direction with respect to the power controller and is disposed to overlie the end face of the power controller as seen from the widthwise direction.

### CROSS-REFERENCE TO RELATED APPLICATIONS

The present application claims priority under 35 U.S.C. §119 to Japanese Patent Application No. 2011-248159, filed Nov. 14, 2011, entitled “Structure For Mounting Power Control Unit On Vehicle Body.” The contents of this application are incorporated herein by reference in their entirety.

### BACKGROUND OF THE INVENTION

1. Field of the Invention

The disclosure relates to a mount structure to mount a power controller on a vehicle body.

2. Discussion of the Background

A motor room located in the front portion of the vehicle body of a conventional electric automobile incorporates a motor resiliently supported on the vehicle body, and a power control unit (hereinafter referred to as “PCU”) that is disposed above the motor to control the driving of the motor. The PCU and the motor are connected by power supply lines through which power is supplied from the PCU to the motor.

As illustrated in, for example, Japanese Unexamined Patent Application Publication No. 2011-20628, the power supply line has one end attached to a connector receptacle provided on an end face of an inverter in the widthwise direction of a vehicle, and then runs down along the end face in the widthwise direction of the vehicle. Then, the other end of the power supply line is laid between the inverter and the motor in the widthwise direction of the vehicle to be connected to a motor-side connector member provided on the motor.

When a vehicle has an impact on its side (hereinafter referred to as “side impact”) or the like, the impact load applied from the side portion of the vehicle body thrusts the peripheral members of the inverter (e.g., low-voltage battery) in toward the inverter.

### SUMMARY OF THE INVENTION

According to one aspect of the present invention, a mount structure to mount a power controller on a vehicle body includes a power supply line and a unit support frame. The power supply line is provided to electrically connect the power controller to a drive motor. The power controller is configured to convert power from a power source to desired power and is configured to supply the desired power to the drive motor via the power supply line to control driving of the drive motor. The power supply line includes a wiring connecting portion to be connected to the power controller, and an outer wiring portion extending from the wiring connecting portion along an end face of the power controller. The end face is provided to face in a widthwise direction of the vehicle body. The unit support frame is to support the power controller and includes a widthwise outer frame extending along the end face of the power controller. The widthwise outer frame is disposed outward of the outer wiring portion in the widthwise direction with respect to the power controller and is disposed to overlie the end face of the power controller as seen from the widthwise direction.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a schematic configurational diagram showing the front portion of an electric automobile according to an exemplary embodiment from one side.

FIG. 2 is a perspective view of the electric automobile illustrating the interior of a motor room.

FIG. 3 is a diagram as seen from an arrow III in FIG. 2.

FIG. 4 is a diagram as seen from an arrow IV in FIG. 2.

### DESCRIPTION OF THE EMBODIMENTS

The embodiments will now be described with reference to the accompanying drawings, wherein like reference numerals designate corresponding or identical elements throughout the various drawings.

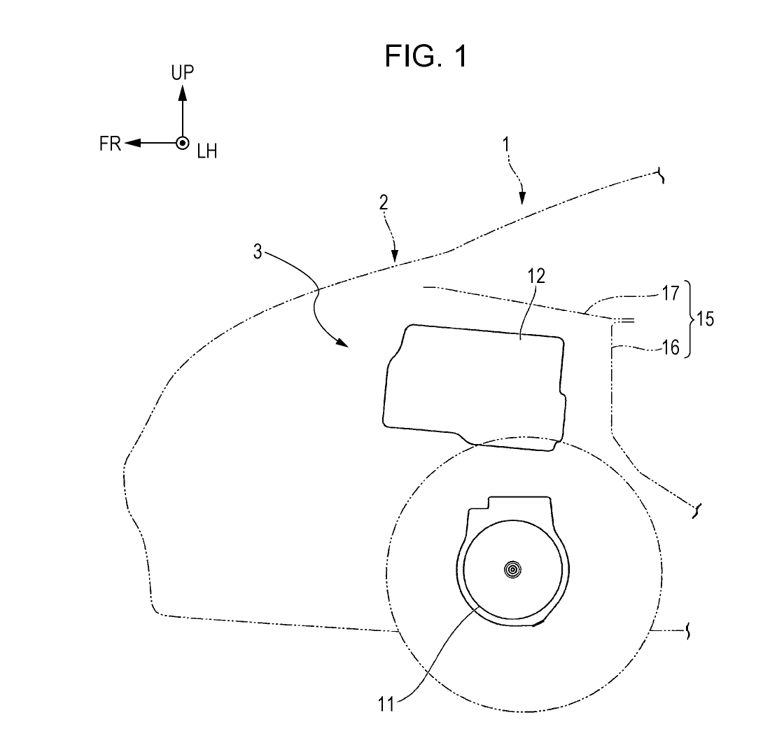

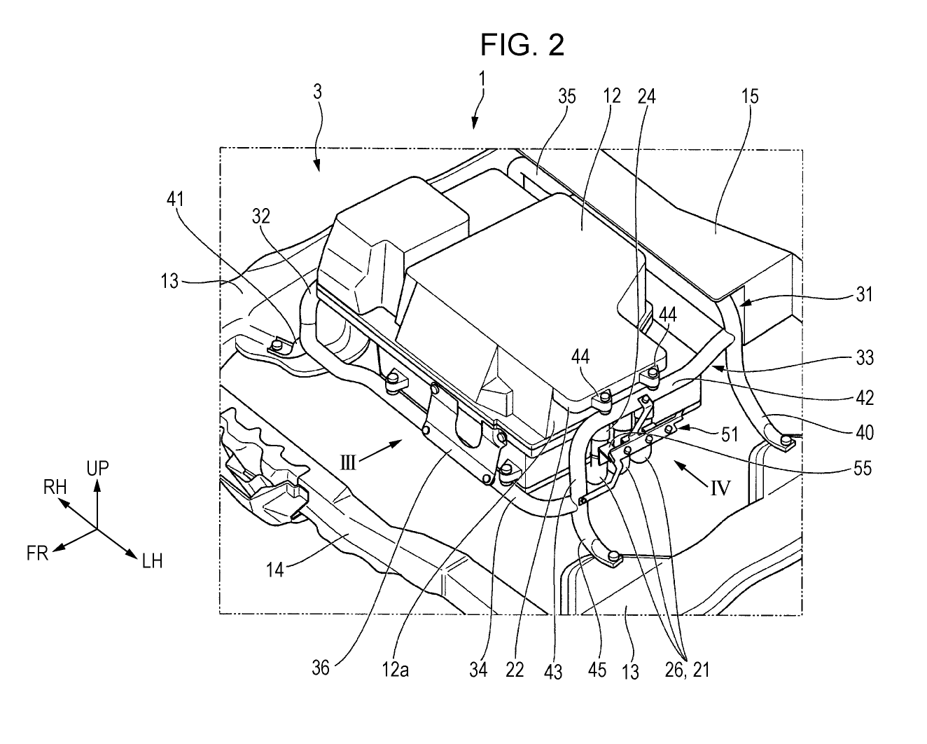

FIG. 1 is a schematic configurational diagram showing the front portion of an electric automobile according to the exemplary embodiment from one side, and FIG. 2 is a perspective view of the electric automobile illustrating the interior of a motor room. The directions, such as front, rear, left and right, are identical to the directions of a vehicle unless otherwise specified. The diagrams referred to hereinafter show the frontward of the vehicle by an arrow “FR”, the upward of the vehicle by an arrow “UP”, the rightward of the vehicle by an arrow “RH”, and the leftward of the vehicle by an arrow “LH”.

As shown in FIGS. 1 and 2, a motor room 3 is defined in the front portion of a vehicle body 2 of an electric automobile 1 according to the embodiment. A motor (drive motor) 11 as a drive source is disposed at the inner lower portion of the motor room 3, and a PCU 12 is disposed at the inner upper portion of the motor room 3.

As shown in FIG. 2, a pair of side frames 13 extending in the front-rear direction on the left and right sides of the vehicle body 2, and a front frame 14 that connects the front ends of the side frames 13 together are provided at the lower portion of the motor room 3. As shown in FIG. 1, a dashboard 15 that defines an unillustrated vehicle interior and the interior of the motor room 3 in the front-rear direction is provided at the rear portion of the motor room 3. The dashboard 15 includes a dashboard lower section 16 located rearward of the PCU 12 and extending along the up-down direction, and a dashboard upper section 17 consecutively extending frontward from the upper end of the dashboard lower section 16.

As shown in FIG. 1, the motor 11 is formed cylindrical, and is resiliently supported on the vehicle body 2 via an unillustrated antivibration member with its rotating shaft facing in the left-right direction.

As shown in FIG. 2, the PCU 12 is formed in a parallelepiped shape with its in the left-right direction (widthwise direction) being the lengthwise direction, is supported on the side frames 13 via a unit support frame 31 to be described later, and is disposed above the motor 11. The PCU 12 is electrically connected with, for example, a high-voltage battery (not shown) disposed at a lower portion of the vehicle interior by a power cable (not shown) to convert DC power supplied from the high-voltage battery to three-phase (U phase, V phase and W phase) AC power. Further, the PCU 12 is electrically connected to the motor 11 phase by phase by power supply lines 21, so that the three-phase AC power converted by the PCU 12 is supplied to the motor 11 to control the driving of the motor 11.

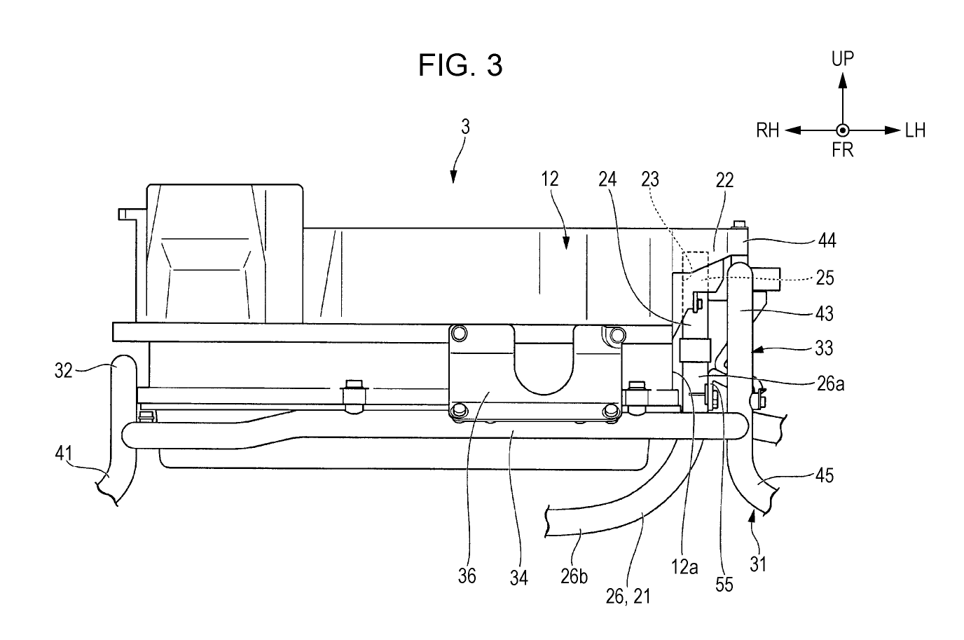

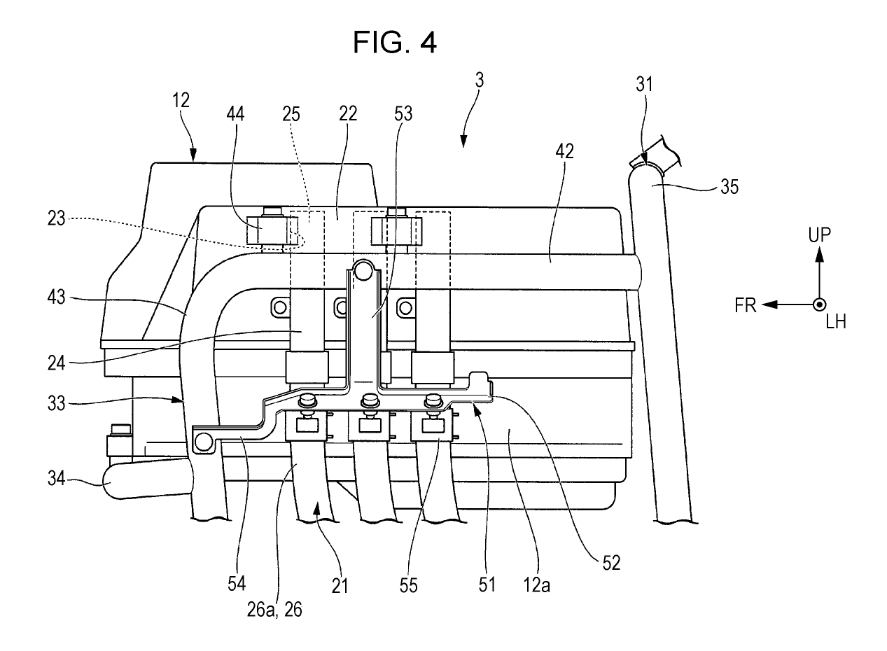

FIG. 3 is a diagram as seen from an arrow III in FIG. 2, and FIG. 4 is a diagram as seen from an arrow IV in FIG. 2.

As shown in FIGS. 2 to 4, a PCU-side terminal box 22 for connecting the power supply lines 21 to the PCU 12 is formed in the PCU 12. The PCU-side terminal box 22 protrudes outward (leftward) in the left-right direction, at the upper portion of the PCU 12, from an end face 12a positioned on one side of the left-right direction (hereinafter referred to as “left end face 12a”). A plurality of guide sections 23 for guiding the power supply lines 21 into the PCU 12 phase by phase are formed side by side in the front-rear direction in the PCU-side terminal box 22. Those guide sections 23 are holes each connecting the interior and exterior of the PCU 12 extend along the up-down direction with their openings facing downward.

Each of the power supply lines 21, which is a flexible cable, includes a PCU-side connecting portion (wiring connecting portion) 25 to be connected to the PCU 12, a motor-side connecting portion (not shown) to be connected to the motor 11, and an intermediate portion 26 exposed through the PCU 12 and the motor 11 and bridging therebetween.

Each PCU-side connecting portion 25 is mounted via a connector 24 from the lower end opening of the respective individual guide section 23, and is guided into the PCU-side terminal box 22. Terminals at the distal ends of the PCU-side connecting portions 25 are connected to a plurality of unillustrated bus bars, phase by phase, in the PCU-side terminal box 22 to serve as electric connecting parts, and are connected to various electric devices accommodated in the PCU 12 via the bus bars.

Each motor-side connecting portion is mounted to an unillustrated motor-side terminal box of the motor 11 via a connector. The motor-side connecting portions are connected to a plurality of unillustrated bus bars, phase by phase, in the motor-side terminal box to be electrically connected to the motor 11 via the bus bars.

The individual intermediate portions 26 are laid in parallel between the PCU-side connecting portions 25 and the motor-side connecting portions. Specifically, each intermediate portion 26 has an outer wiring portion 26a laid outward (leftward) of the PCU 12, and a lower wiring portion 26b laid under the PCU 12, as shown in FIG. 3.

The outer wiring portions 26a are led out downward from the PCU-side terminal box 22, and are then laid downward along the left end face 12a of the PCU 12.

Each lower wiring portion 26b is provided consecutively from the lower end of the outer wiring portion 26a, and is laid around downward of the PCU 12. The lower wiring portion 26b is laid toward the other side (e.g., right side) of the PCU 12 in the left-right direction along the bottom surface of the PCU 12 to be consecutive to the aforementioned motor-side connecting portion.

The PCU 12 structured in the above manner is supported on the unit support frame 31 shown in FIGS. 2 to 4 in the motor room 3. The unit support frame 31 is a pipe-like member laid to surround the entire periphery of the PCU 12. Specifically, the unit support frame 31 has a right-side support frame 32 disposed on the right side to the PCU 12, a left-side support frame (widthwise outer frame) 33 disposed on the left side thereto, a front support frame 34 that connects the front ends of the individual side support frames 32, 33, and a rear support frame 35 that connects the rear ends of the individual side support frames 32, 33.

First, the front support frame 34 extends along the lower portion of the PCU 12 in the left-right direction in front of the PCU 12, and its both end portions along the extending direction are bent rearward. The front surface of the PCU 12 is fastened to the front support frame 34 at a plurality of locations along the left-right direction. A plate-like guard bracket 36 is provided at the left portion of the front side of the PCU 12. The guard bracket 36 is inclined frontward from the upper end toward the lower end, with the upper end being fastened to the front side of the PCU 12 and the lower end being fastened to the front support frame 34.

The rear support frame 35 extends along the upper portion of the PCU 12 in the left-right direction at the back of the PCU 12, and its both end portions along the extending direction are bent downward. The aforementioned dashboard 15 is fastened to the rear support frame 35 at a plurality of locations along the left-right direction. The lower end of both ends of the rear support frame 35 which extend along the extending direction forms legs 40 bent outward in the left-right direction with respect to the PCU 12. The legs 40 are fastened to the rear sides of the respective side frames 13.

The right-side support frame 32 extends along the front-rear direction on the right side of the PCU 12. The other end face of the left and right end faces of the PCU 12 (hereinafter referred to as “right end face”) is fastened to the right-side support frame 32 at a plurality of locations along the front-rear direction. The right-side support frame 32 has a front end connected to the right end of the front support frame 34, and a rear end connected to the right end of the rear support frame 35.

Legs 41 extend downward from the joint portions between the right-side support frame 32 and the front support frame 34. The legs 41 extend gradually outward (rightward) with respect to the PCU 12 from the upper end to the lower end. The lower ends of the legs 41 are fastened to the front side of the right side frame 13 in the side frames 13.

The left-side support frame 33 extends on the left side of the PCU 12 and outward of the power supply lines 21 (PCU-side connecting portions 25 and outer wiring portions 26a) with respect to the PCU 12 along the left end face 12a of the PCU 12. Specifically, the left-side support frame 33 includes a front-rear frame 42 extending along the front-rear direction, and an up-down frame 43 provided consecutively at the front end of the front-rear frame 42 and extending downward therefrom.

The front-rear frame 42 extends along the front-rear direction at a position in the left-right direction at which the front-rear frame 42 faces the upper portion of the left end face 12a of the PCU 12. Mount pieces 44 protruding leftward from the upper end of the PCU-side terminal box 22 are supported on the front-rear frame 42. The PCU 12 is fastened to the front-rear frame 42 by the mount pieces 44. In the illustrated example, the mount pieces 44 are formed at two locations of the PCU-side terminal box 22 along the front-rear direction. The rear end of the front-rear frame 42 is connected to an up-down directional intermediate portion of the left end of the rear support frame 35. The front end of the front-rear frame 42 is located rearward of the front side of the PCU 12, and frontward of the PCU-side terminal box 22 in the front-rear direction. That is, the front end of the front-rear frame 42 is located frontward of the front one of the individual PCU-side connecting portions 25 in the front-rear direction.

The up-down frame 43 is formed bent downward from the front end of the front-rear frame 42, and the left end of the front support frame 34 is connected to an up-down directional intermediate portion of the up-down frame 43. The lower end of the up-down frame 43 forms legs 45 bent outward (leftward) in the left-right direction with respect to the PCU 12. The legs 45 are fastened to the front side of the left side frame 13 in the side frames 13.

Therefore, the left-side support frame 33 is disposed at a position overlying the left end face 12a of the PCU 12 as seen from the left-right direction (widthwise direction of the vehicle). Further, the individual power supply lines 21 (PCU-side connecting portions 25 and outer wiring portions 26a) are disposed between the left-side support frame 33 and the left end face 12a of the PCU 12 in the left-right direction. Specifically, the front-rear frame 42 of the left-side support frame 33 is disposed at a position overlying the PCU-side connecting portion 25 as seen from the left-right direction at the upper portion of the left end face 12a of the PCU 12. The up-down frame 43 is disposed at a position overlying the front portion of the left end face 12a of the PCU 12 as seen from the left-right direction.

As shown in FIG. 4, the left-side support frame 33 is provided with a bracket (holding member) 51 that holds the outer wiring portions 26a of the intermediate portions 26 of the power supply lines 21. The bracket 51 includes a bracket body 52 that holds the individual outer wiring portions 26a, a first stay 53 bridging between the bracket body 52 and the front-rear frame 42, and a second stay 54 bridging between the bracket body 52 and the up-down frame 43.

The bracket body 52 is formed like a plate extending outward of the outer wiring portions 26a along the layout direction of the power supply lines 21, i.e., the front-rear direction with respect to the PCU 12, at a portion positioned below the front-rear frame 42 and at the back of the up-down frame 43.

The first stay 53 extends upward from a front-rear directional intermediate portion of the bracket body 52, and has an upper end fastened to the front-rear directional intermediate portion of the front-rear frame 42.

The second stay 54 is bent downward from the front end of the bracket body 52, and extends frontward. The second stay 54 has a front end fastened to the up-down directional intermediate portion of the up-down frame 43.

A plurality of clips 55 that individually hold the respective outer wiring portions 26a are attached to positions corresponding to the individual outer wiring portions 26a in the front-rear direction of the bracket body 52. The clips 55 are attached to the bracket body 52 in such a way as to face inward with respect to the PCU 12, and individually hold the respective outer wiring portions 26a from both sides in the diametrical direction. Accordingly, the power supply lines 21 are collectively held by the bracket body 52.

According to the embodiment, as apparent from the above, the left-side support frame 33 is disposed outward of the outer wiring portions 26a with respect to the PCU 12, and in such a way as to overlie the left end face 12a of the PCU 12 as seen from outside the left-right direction.

According to the configuration, the power supply lines 21 (PCU-side connecting portions 25 and outer wiring portions 26a) can be protected by the left-side support frame 33. That is, if an impact load is applied from, for example, the left side of the vehicle body 2 at the time of side impact, even when a peripheral member of the PCU 12 (e.g., low-voltage battery) is thrust in toward the power supply lines 21, the movement of the peripheral member toward the power supply lines 21 can be restricted by the left-side support frame 33. This makes it possible to inhibit the peripheral member from contacting the power supply lines 21, thus inhibiting the power supply lines 21 from being damaged.

The left-side support frame 33 supporting the PCU 12 itself serves to protect the power supply lines 21, thus leading to reduction in the quantity of components compared to, for example, the case where a separate protective member is attached.

Further, the left-side support frame 33 includes the up-down frame 43 extending along the up-down direction in front of the power supply lines 21, so that if an impact load applied from the front side of the vehicle body 2 thrusts a peripheral member rearward at the time of front impact, the movement of the peripheral member toward the power supply lines 21 can be restricted by the up-down frame 43. This makes it possible to inhibit the peripheral member from contacting the power supply lines 21, thus inhibiting the power supply lines 21 from being damaged.

The outer wiring portions 26a of the individual power supply lines 21 are held on the left-side support frame 33 by the bracket 51, so that the rocking of the power supply lines 21 can be inhibited from being transmitted to the electric connecting portions between the PCU-side connecting portions 25 and the bus bars in the PCU-side terminal box 22. That is, the PCU 12 and the PCU-side connecting portions 25 of the power supply lines 21 vibrate in phase, and the intermediate portions 26 of the power supply lines 21 rock with respect to the PCU 12 and the PCU-side connecting portions 25 of the power supply lines 21. This makes it possible to suppress stress which is generated at the electric connecting portions between the PCU-side connecting portions 25 and the bus bars in the PCU-side terminal box 22, thus suppressing damages on the electric connecting portions of the PCU-side connecting portions 25.

Moreover, because the bracket 51 holds the outer wiring portions 26a of the power supply lines 21, the positions close to the electric connecting portions of the PCU-side connecting portions 25 of the power supply lines 21 can be held, thus making it possible to effectively inhibit rocking of the intermediate portions 26 of the power supply lines 21 from being transmitted to the electric connecting portions of the PCU-side connecting portions 25.

What is more, because the first stay 53 and the second stay 54 of the bracket 51 are respectively fastened to the front-rear frame 42 and the up-down frame 43 of the left-side support frame 33, it is easy to secure the fastening positions of the first stay 53 and the second stay 54 on the left-side support frame 33. In addition, the stays 53, 54 are respectively fixed to the frames 42, 43 extending in different directions, so that the PCU-side connecting portions 25 can be surely fixed to the unit support frame 31 even against the rocking of the power supply lines 21 in each direction. Accordingly, the bracket 51 can be fixed to the left-side support frame 33 more tightly, thus making it possible to surely inhibit the electric connecting portions of the PCU-side connecting portions 25 of the power supply lines 21 from being damaged.

The scope of the disclosure is not limited to the foregoing embodiment, and encompass various modifications made to the embodiment without departing from the scope of the disclosure. In other words, the configuration or the like of the foregoing embodiment is to be considered as illustrative and not restrictive, and may be modified as needed.

For example, although the foregoing description of the embodiment has been given of the case where the disclosure is adapted to the electric automobile 1 that is driven on a high-voltage battery as a power source, this case is not restrictive, and the disclosure may be adapted to a fuel-cell vehicle using a fuel cell as a power source.

Further, the design on the shape of the unit support frame 31 may be changed as needed as long as the left-side support frame 33 is disposed outward of the power supply lines 21 in the left-right direction with respect to the PCU 12, and is disposed so as to overlie the left end face 12a of the PCU 12 as seen from the left-right direction. That is, the up-down directional designed position of the left-side support frame 33 may be changed within the up-down directional height of the PCU 12 as needed.

Furthermore, the wiring routes to the motor 11 may be changed as needed as long as the power supply lines 21 are laid along at least an end face of the PCU 12.

Although the foregoing description of the embodiment has been given of the configuration in which the PCU 12 is disposed above the motor 11, the positional relation may be changed as needed.

In addition, the components of the above-described embodiment may be replaced with well-known components without departing from the scope of the disclosure.

According to one aspect of an exemplary embodiment, there is provided a mount structure for mounting a power control unit (e.g., PCU 12 in the exemplary embodiment), which converts power from a power source to desired power and supplying the desired power to a drive motor (e.g., motor 11 in the exemplary embodiment) to control driving of the drive motor, on a vehicle body (e.g., vehicle body 2 in the exemplary embodiment), the mount structure including a unit support frame (e.g., unit support frame 31 in the exemplary embodiment) that supports the power control unit, the unit support frame including a widthwise outer frame (e.g., left-side support frame 33 in the exemplary embodiment) extending along an end face (e.g., left end face 12a in the exemplary embodiment) of the power control unit in a widthwise direction of the vehicle body, and a power supply line (e.g., power supply line 21 in the exemplary embodiment) that electrically connects the power control unit to the drive motor, the power supply line including a wiring connecting portion (e.g., PCU-side connecting portion 25 in the exemplary embodiment) to be connected to the power control unit, and an outer wiring portion (e.g., outer wiring portion 26a in the exemplary embodiment) extending from the wiring connecting portion along the end face of the power control unit, the widthwise outer frame being disposed outward of the outer wiring portion in the widthwise direction with respect to the power control unit, and being disposed to overlie the end face of the power control unit as seen from the widthwise direction.

According to this aspect of the exemplary embodiment, the power supply line can be protected by the widthwise outer frame (wiring connecting portion and outer wiring portion). That is, if an impact load is applied from the side portion of the vehicle body at the time of side impact, even when a peripheral member of the power control unit (e.g., low-voltage battery) is thrust in toward the power supply line, the movement of the peripheral member toward the power supply line can be restricted by the widthwise outer frame. This makes it possible to inhibit the peripheral member from contacting the power supply line, thus inhibiting the power supply line from being damaged.

The widthwise outer frame supporting the power control unit itself serves to protect the power supply line, thus leading to reduction in the quantity of components compared to, for example, the case where a separate protective member is attached.

It is preferable that in the mount structure according to the aspect of the exemplary embodiment, the widthwise outer frame should include a front-rear frame (e.g., front-rear frame 42 in the exemplary embodiment) extending along a front-rear direction of the vehicle body, and an up-down frame (e.g., up-down frame 43 in the exemplary embodiment) extending along an up-down direction of the vehicle body in front of the power supply line.

According to this mount structure of the exemplary embodiment, the widthwise outer frame includes the up-down frame extending along the up-down direction in front of the power supply line, so that if an impact load applied from the front side of the vehicle body thrusts a peripheral member rearward at the time of front impact, the movement of the peripheral member toward the power supply line can be restricted by the up-down frame. This makes it possible to inhibit the peripheral member from contacting the power supply line, thus inhibiting the power supply line from being damaged.

It is preferable that in the mount structure according to the aspect of the exemplary embodiment, a holding member (e.g., bracket 51 in the exemplary embodiment) that holds the outer wiring portion of the power supply line should be fixed to the widthwise outer frame.

According to this mount structure of the exemplary embodiment, the outer wiring portion of the power supply line is held on the widthwise outer frame by the holding member, so that the rocking of the power supply line can be inhibited from being transmitted to the wiring connecting portion. This makes it possible to suppress stress which is generated at the wiring connecting portion of the power supply line, thus suppressing damages on the wiring connecting portion.

It is preferable that in the mount structure according to the aspect of the exemplary embodiment, the holding member should be coupled to both of the front-rear frame and the up-down frame of the widthwise outer frame.

According to this mount structure of the exemplary embodiment, the holding member is coupled to both of the front-rear frame and the up-down frame of the widthwise outer frame, thus making it easier to secure the fastening position of the holding member. Because the holding member is fixed to frames extending in different directions (front-rear frame and up-down frame), the wiring connecting portion can be surely fixed to the unit support frame even against rocking of the power supply line in each direction. Accordingly, the holding member can be fixed to the widthwise outer frame more firmly, surely inhibiting the wiring connecting portion of the power supply line from being damaged.

Obviously, numerous modifications and variations of the present invention are possible in light of the above teachings. It is therefore to be understood that within the scope of the appended claims, the invention may be practiced otherwise than as specifically described herein.

What is claimed is:

1. A mount structure to mount a power controller on a vehicle body, the mount structure comprising:
a power supply line provided to electrically connect the power controller to a drive motor, the power controller being configured to convert power from a power source to desired power and configured to supply the desired power to the drive motor via the power supply line to control driving of the drive motor, the power supply line comprising:
a wiring connecting portion to be connected to the power controller; and
an outer wiring portion extending from the wiring connecting portion along an end face of the power controller, the end face being provided to face in a widthwise direction of the vehicle body; and
a unit support frame to support the power controller and including a widthwise outer frame extending along the end face of the power controller, the widthwise outer frame being disposed outward of the outer wiring portion in the widthwise direction with respect to the power controller and being disposed to overlie the end face of the power controller as seen from the widthwise direction.

2. The mount structure according to claim 1, wherein the widthwise outer frame includes a front-rear frame extending along a front-rear direction of the vehicle body, and an up-down frame extending along an up-down direction of the vehicle body and provided on a front side with respect to the power supply line in the front-rear direction.

3. The mount structure according to claim 2, further comprising:
a holding member holding the outer wiring portion of the power supply line and connected to the widthwise outer frame of the unit support frame.

4. The mount structure according to claim 3, wherein the holding member is coupled to both of the front-rear frame and the up-down frame of the widthwise outer frame.

5. The mount structure according to claim 4, wherein the wiring connecting portion is provided between the front-rear frame and the end face of the power controller in the widthwise direction.

6. The mount structure according to claim 5, wherein the holding member is provided below the front-rear frame.

7. The mount structure according to claim 2, wherein the wiring connecting portion is provided between the front-rear frame and the end face of the power controller in the widthwise direction.

8. The mount structure according to claim 2, wherein the power controller is connected to the front-rear frame.

9. The mount structure according to claim 1, wherein the wiring connecting portion is provided between the widthwise outer frame and the end face of the power controller in the widthwise direction.

10. The mount structure according to claim 1,
wherein the power controller is connected to the unit support frame, and
wherein the unit support frame is connected to the vehicle body.
